(19) United States
(12) Patent Application Publication
(10) Pub. No.: US 2026/0037009 A1
(43) Pub. Date: Feb. 5, 2026

(54) AUTOMATED PERFORATION OF IN-SITU GROUND COVERING

(71) Applicant: Thomas Pettit Munson, Lake Stevens, WA (US)

(72) Inventor: Thomas Pettit Munson, Lake Stevens, WA (US)

(21) Appl. No.: 19/246,971

(22) Filed: Jun. 24, 2025

Related U.S. Application Data
(60) Provisional application No. 63/678,758, filed on Aug. 2, 2024.

(51) Int. Cl. G05D 3/12; A01C 11/00; F23D 14/46; G05D 111/50

(52) U.S. Cl. CPC G05D 3/121; A01C 11/006; F23D 14/465; G05D 2111/54

(57) ABSTRACT

Systems and methods for forming holes in a ground cover material as a vehicle travels over terrain. The methods comprise: detecting when a mobility mechanism of the vehicle or a machine coupled to the vehicle has moved in a direction by a certain amount; generating a control signal by a controller responsive to said detecting; communicating the control signal from the controller to a heat source; producing heat by the heat source in response to the control signal; and using the heat to form a hole in the ground cover material as the vehicle travels at a speed over the terrain.

### CROSS-REFERENCE TO RELATED APPLICATION

The present application claims priority to and the benefit of U.S. Provisional Patent Application No. 63/678,758 filed on Aug. 2, 2024. The content of this U.S. Provisional patent application is incorporated herein by reference in its entirety.

### BACKGROUND

### Description of the Related Art

Existing mechanical transplanters are able to plant through installed plastic mulch. However, mechanical transplanters are unable to plant through tougher, stronger ground coverings such as woven weed barriers. Attempts have been made to modify mechanical transplanters to push or cut through installed ground coverings such as a woven weed barrier. However, they have not been successful. Manual methods to cut or burn penetrations in installed ground coverings are available. They are inaccurate with respect to the planting location of a mechanical transplanter, inconsistent in size, and time consuming to make.

### SUMMARY

The present document concerns implementing systems and methods for forming holes in a ground cover material as a vehicle travels over terrain. The methods comprise: detecting when a mobility mechanism of the vehicle or a machine coupled to the vehicle has moved in a direction by a certain amount; generating a control signal by a controller responsive to said detecting; communicating the control signal from the controller to a heat source; producing heat by the heat source in response to the control signal; and using the heat to form a hole in the ground cover material as the vehicle travels at a speed over the terrain.

The present document also concerns a system comprising a vehicle and a heating mechanism coupled to the vehicle. The heating mechanism comprises: a detector configured to detect when a mobility mechanism of the vehicle or a machine coupled to the vehicle has moved in a direction by a certain amount; a controller configured to generate a control signal responsive to an actuation of the switch; and a heat source configured to receive the control signal from the controller and produce heat in response to a reception of the control signal. The heat is used to form a hole in a ground cover material as the vehicle travels at a speed over the terrain.

### BRIEF DESCRIPTION OF THE DRAWINGS

This disclosure is facilitated by reference to the following drawing figures, in which like numerals represent like items throughout the figures, and in which:

FIG. 1 provides a top view of a tractor with a mechanical transplanter coupled thereto.

FIG. 2 provides a side view of the mechanical transplanter shown in FIG. 1.

FIG. 3 provides a side of a mechanical transplanter having the present solution installed thereon.

FIG. 4 provides a top view of the mechanical transplanter shown in FIG. 3.

FIGS. 5A-5B (collectively referred to as “FIG. 5”) provide illustrations of a mechanism to heat and perforate a ground cover material.

FIG. 6 provides a side view of the mechanism shown in FIG. 5.

FIG. 7 provides a top view of a timing mechanism to locate perforation(s) with respect to the planting location of the mechanical transplanter.

FIG. 8 provides a side view of the timing mechanism shown in FIG. 7.

FIG. 9 provides a block diagram of an illustrative computing device.

FIG. 10 provides a flow diagram of an illustrative method for forming holes in a ground cover material as a vehicle travels over terrain.

### DETAILED DESCRIPTION

The present document concerns a device that automatically perforates in-situ ground covering(s) based on the position of an apparatus such as the planting location of a mechanical transplanter. The device includes a timing mechanism, heat source, and circuitry and logic elements (also known as the controller). The timing mechanism and controller determine when the heat source should be switched on or off based on the position of an apparatus such as the planting location of a mechanical transplanter. The controller also includes logic to limit the maximum heating duration, an emergency stop, and other features to improve safety and performance. The heat source perforates an in-situ woven weed barrier or similar ground covering. With the perforation(s) in the correct position, an apparatus such as a mechanical transplanter can place items such as plants through the perforation(s) in the in-situ woven weed barrier or similar ground covering(s).

The device is generally configured to automatically locate and create penetrations through in-situ ground covering material(s) based on the position of an apparatus. One use of the present solution is to create penetrations in a ground covering, such as woven weed barrier, based on the planting location(s) of a mechanical transplanter. The user is not required to measure, cut and/or to perform any additional steps to locate and create penetrations in the ground cover prior to using a mechanical transplanter or similar device. Rather, the present solution accurately locates penetrations in installed ground covering with respect to an apparatus such as mechanical transplanter.

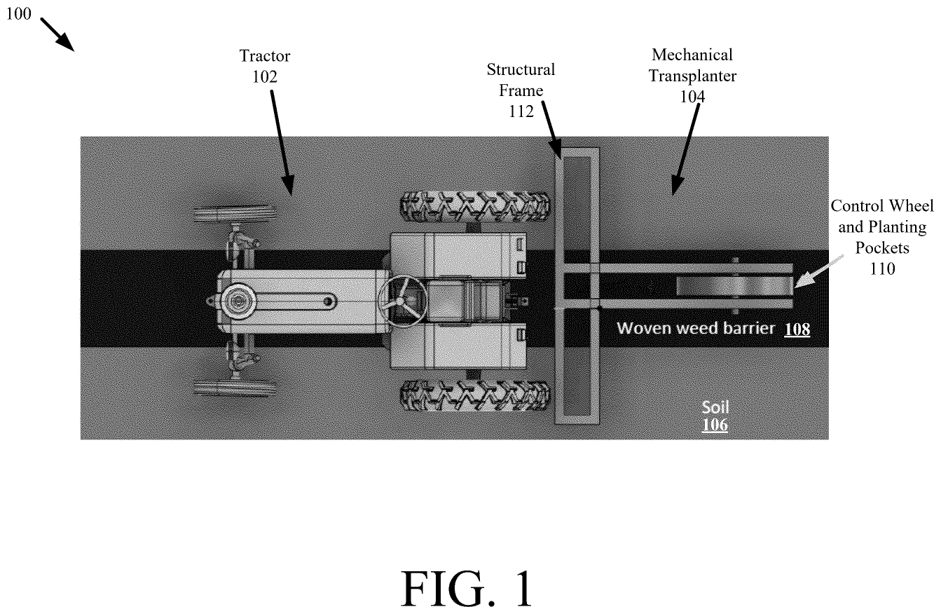

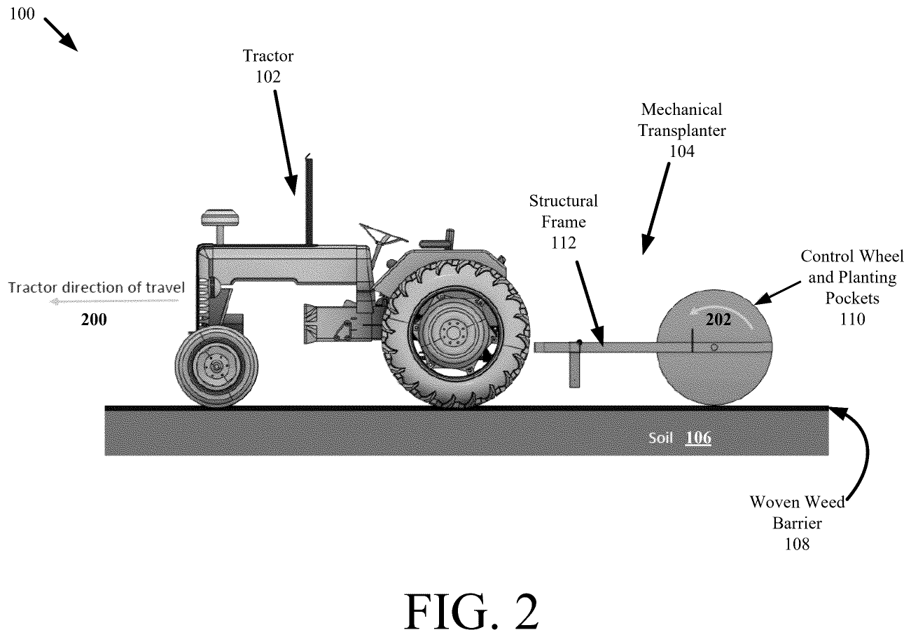

FIG. 1 provides a top view of a system 100 configured to plant seeds or seedlings in rows within the soil 106. FIG. 2 provides a side view of system 100. System 100 comprises a tractor 102 with a mechanical transplanter 104 coupled thereto. The mechanical transplanter 104 comprises a structural frame 112 to which a control wheel 110 is rotatably coupled. The control wheel 110 is provided with planting pockets 110 to carry and plant the seeds and/or seedling. As the tractor 102 tows the mechanical transplanter 104 over the ground in direction 200, control wheel 110 rotates in direction 202. This allows a certain quantity of seeds or seedlings to leave the planting pockets 110 and be planted in the soil 106 with a pre-specified spacing or distanced therebetween.

In some scenarios, a woven weed barrier 108 is placed over the ground prior to any seed or seedling planting by system 100. Woven weed barriers are well known. The mechanical transplanter 104 is unable to plant the seeds and/or seedlings through the woven weed barrier 108. Thus, a solution is needed to address this issue.

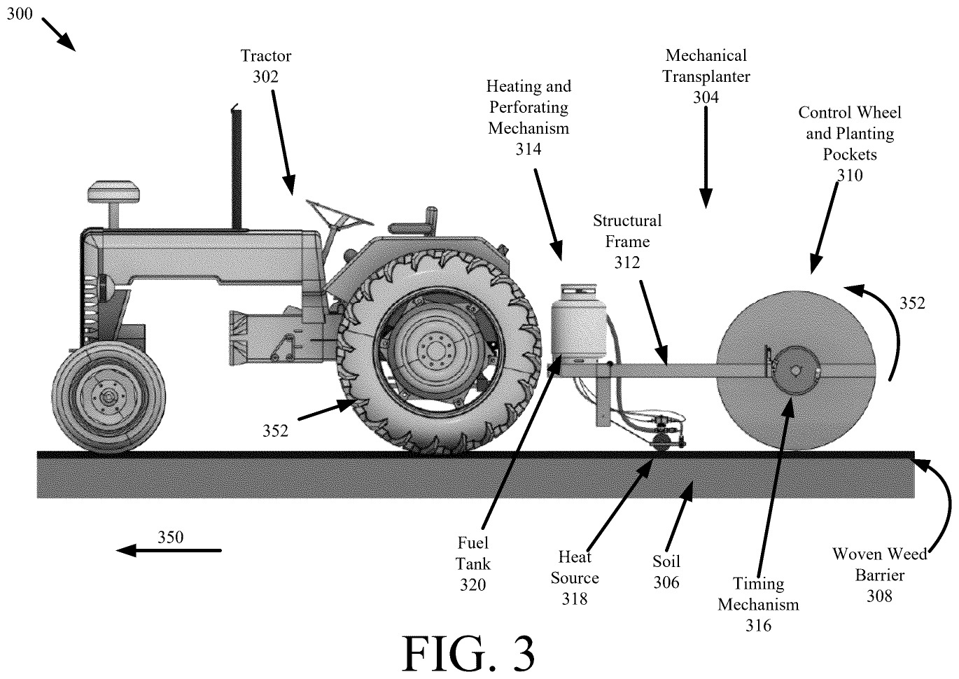

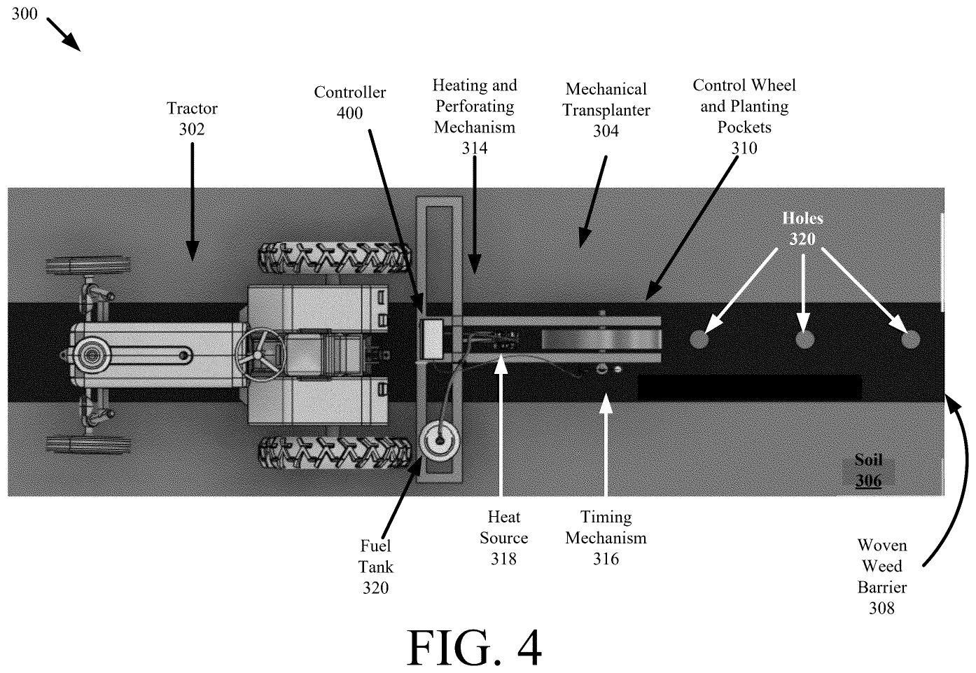

FIG. 3 provides a side view of a system 300 implementing the present solution that allows seeds and/or seedlings to be planted despite the presence of a woven weed barrier disposed on the ground. FIG. 4 provides a top view of system 300. System 300 is configured to plant seeds or seedlings in rows within the soil 306.

System 300 comprises a tractor 302 with a mechanical transplanter 304 coupled thereto. The mechanical transplanter 304 comprises a structural frame 312 to which a control wheel 310 is rotatably coupled. The control wheel 310 is provided with planting pockets 310 to carry and plant the seeds and/or seedling. As the tractor 302 tows the mechanical transplanter 304 over the ground in direction 350, control wheel 310 rotates in direction 352. This allows a certain quantity of seeds or seedlings to leave the planting pockets 310 and be planted in the soil 306 with a pre-specified spacing or distanced therebetween.

A woven weed barrier 308 is placed over the ground prior to any seed or seedling planting by system 300. Woven weed barriers are well known. The woven weed barrier 308 can include, but is not limited to, a land scaping fabric formed of polypropylene or other durable, semi-permeable fabric. The woven weed barrier 308 may be disposed to cover a mounded dirt to suppress weeds. The mechanical transplanter 304 is unable to plant the seeds and/or seedlings through the woven weed barrier 308. Thus, a heating and perforating mechanism 314 is provided to create holes in the woven weed barrier 308 to facilitate the planting of the seeds and/or seedlings.

The heating and perforating mechanism 314 is coupled to the structural frame 312 of the mechanical transplanter 304. The heating and perforating mechanism 314 comprises a fuel tank 320, a heat source 318, a timing mechanism 316 and a controller 400. The fuel can include, but is not limited to, propane, gasoline, and/or diesel. The timing mechanism 316 is configured to monitor the position of the wheel 310. The timing mechanism 316 can include, but is not limited to, sensor(s) configured to measure and/or monitor the position of a rotating wheel. Any known or to be known sensor capable of monitoring, measuring and/or tracking the position of a rotating object can be used here.

The heat source 318 is configured to perforate the woven weed barrier 308. The heat source 318 may be configured to burn the fuel to produce heat and/or power. The controller 400 is configured to monitor operations of heat source 318 and selectively transition the heat source 318 between on ON state and an OFF state. In the ON state, the heat source 318 produces heat and/or power. In the OFF state, the heat source 318 does not produce heat and/or power. The heat source 318 can include, but is not limited to, a hot knife, a torch, a laser, a steamer, and/or another other device that is able to melt and/or cut a woven weed barrier.

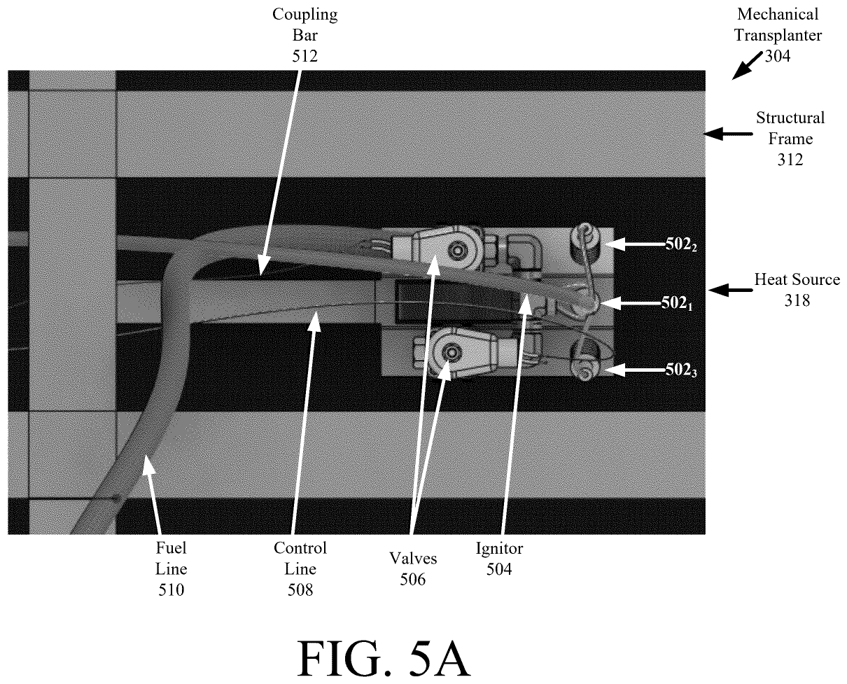

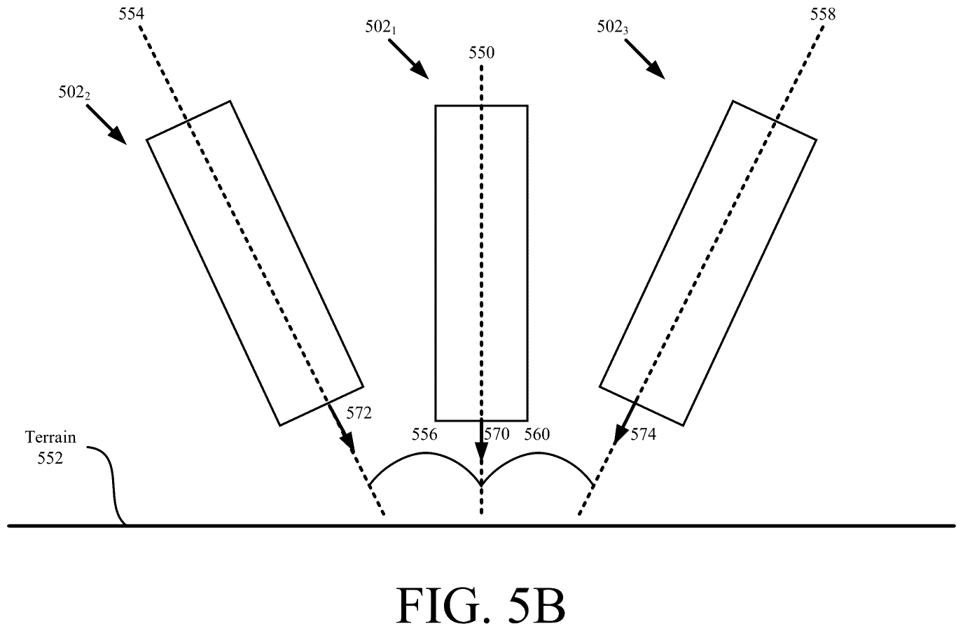

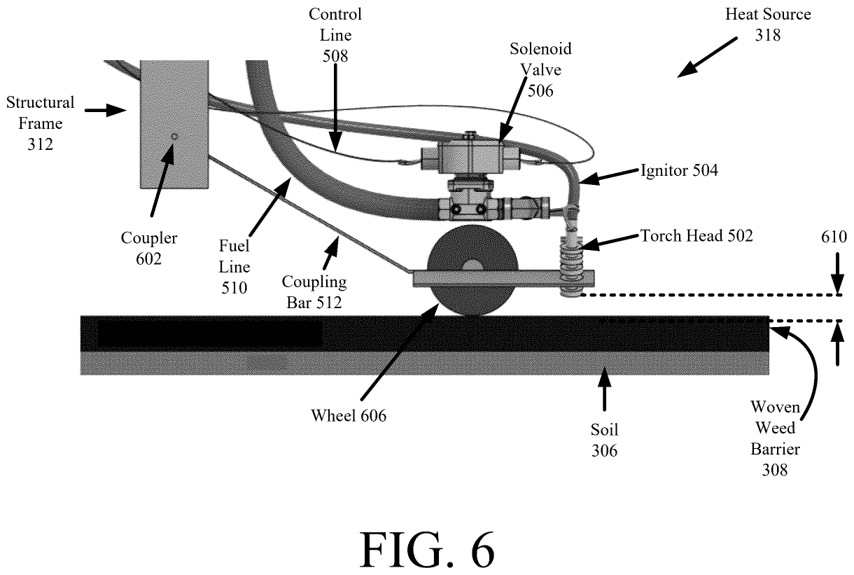

A top view of the heat source 318 is provided in FIG. 5A. A side view of the heat source 318 is provided in FIG. 6. Heat source 318 is rotatably coupled to the structural frame 312 via coupling bar 512 and coupler 602. Coupler 602 can include, but is not limited to, a pin, a nut, a bolt, a washer, and/or a ball bearing. This rotatable coupling allows the wheel 606 of the heat source 318 to roll over and follow the contour of the terrain such that it always touches or is in contact with the terrain (which may or may not be uneven). Consequently, the distance 610 between the torch head(s) 502 and the woven weed barrier 308 remains constant or within a given range of values when the heating and perforating mechanism 314 is in use due to the passive moving up and down of the torch head(s) 502 responsive to undulations in the terrain.

The heat source 318 can include one or more heating elements. The heating elements can include, but are not limited to, torch heads. In FIGS. 5-6, three torch heads are shown including a center torch head 5021 and side torch heads 5022, 5023. As shown in FIG. 5B, the center torch head 5021 has a center axis 550 that is perpendicular to the terrain 552. Torch head 5022 has a center axis 554 which is angled relative to axis 550 of the center torch head 5021. The angle 556 between axis 554 and axis 550 can be selected in accordance with any given application. For example, angle 556 may have a value between one degree and eighty degrees, between ten degrees and thirty degrees, or between fifteen degrees and twenty degrees. The present solution is not limited to the listed ranges of values for angle 556. Torch head 5023 has a center axis 558 which is angled relative to axis 550 of the center torch head 5021. The angle 560 between axis 558 and axis 550 can be selected in accordance with any given application. Angle 560 may be the same as or different than angle 556. The positions of torch heads 5022, 5023 relative to torch head 5021 can be selected to minimize or otherwise reduce the time it takes to heat a given area (towards which the torch heads are pointed) to a particular temperature as the heating and perforating mechanism 314 is traveling at a given speed. The given speed can include, but is not limited to, N miles per hour. N is an integer. For example, N is two.

The torches are configured to burn, melt or otherwise create spaced holes in the woven weed barrier 308 as the heating and perforating mechanism 314 travels over the terrain 552. In this regard, valves 506 are provided to open and close a distal end of a fuel line 510 connected to the torch heads 5021, 5022, 5023. Valves 506 can include, but are not limited to, solenoid valves. A control line 508 electronically and communicatively connects the valves to controller 400. The valves open and close responsive to signals received from controller 400 via control line 508. When the valves are open, an igniter 504 may be activated for igniting the fuel in the torch heads 5021, 5022, 5023. The igniter 504 may be deactivated when the valves are closed.

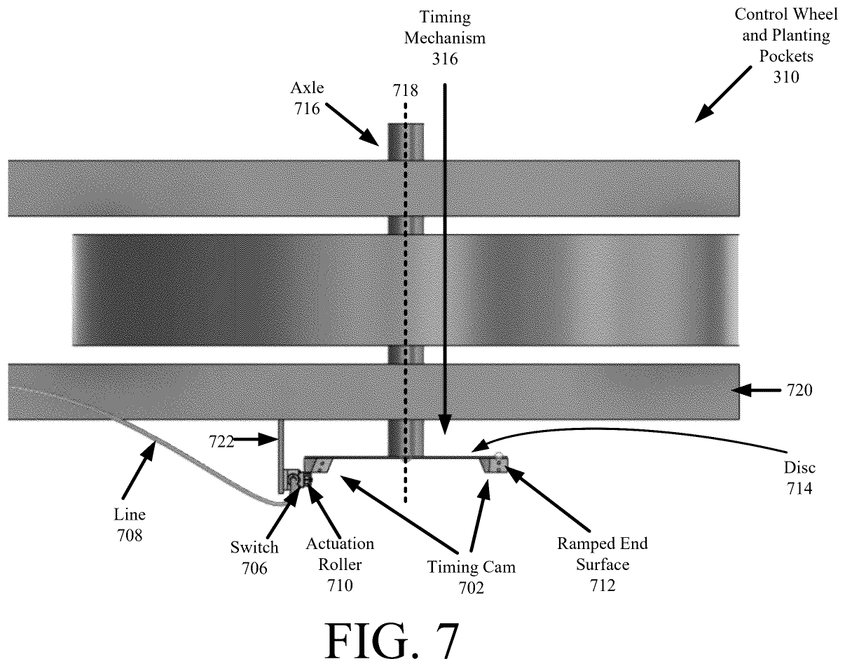

Control of the heat source 318 can be based on signals, data and/or other information received from timing mechanism 316. The timing mechanism 316 is communicatively connected to the controller 400 via a line 708. Although a wired connection is shown in FIG. 7 via line 708, the present solution is not limited in this regard. The communicative connection between the timing mechanism 316 and controller 400 may be wireless. Any known or to be known wireless communication technique can be used here. The timing mechanism 316 is generally configured to generate and send a signal to the controller 400 for triggering or otherwise causing the heat source 318 to create a hole in the woven weed barrier 308 as the tractor 302 travels at a given speed over terrain 552. The manner in which the signal is generated by the timing mechanism 316 will become evident as the discussion progresses.

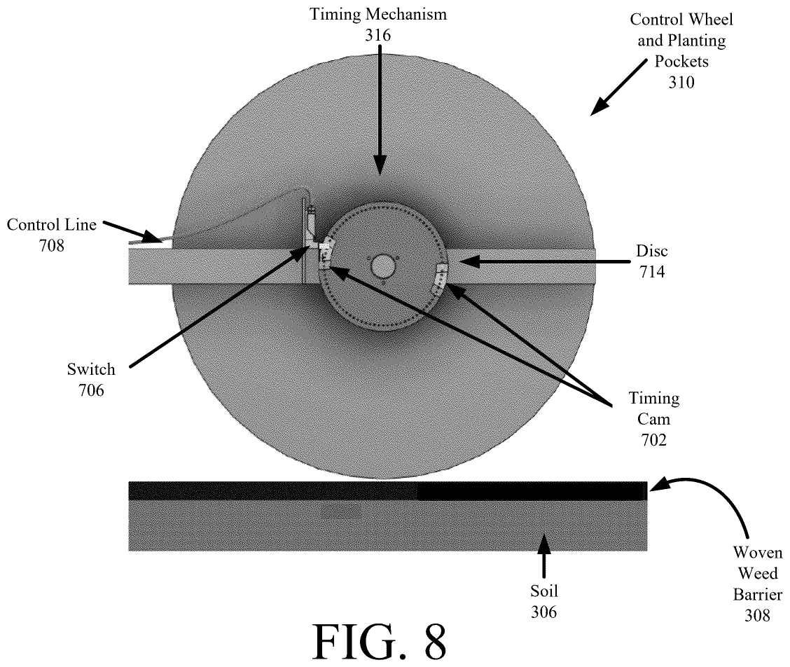

As shown in FIGS. 7-8, the timing mechanism 316 comprises a disc 714 with timing cams 702 coupled thereto. Each timing cam 702 may optionally have a ramped end surface 712 on each of two opposing ends. Disc 714 may be formed of plastic, metal or other material. The timing cams 702 may be formed of plastic, wood or other material. The timing cams 702 are sized and shaped to engage with actuation roller 710 of a switch 706. In this regard, it should be understood that the disc 714 is coupled to an axle 716 such that it rotates along with the axle 716 and plating pockets 310. The disc 714 is connected to the axle 716 in manner that allows the disc 714 to rotate in two opposing direction. Any known or to be known technique for connecting an object to an axel can be used here. Switch 706 is structurally supported and suspended by parts 720, 722 in a surrounding environment whereby switch 706 is located adjacent to, close to, near, or proximate to disc 714. For example, the switch 706 is structurally supported and suspended so as to be located less than, equal to or greater than M inches (or other unit of measure) from the disc 714. M is any number greater than zero. Parts 720, 722 are sized and shaped to maintain a constant position or location of the switch 706 relative to the disc 714 at all times.

As the disc 714 rotates, the timing cams 702 rotate about a central axis 718 of the disc 714. The timing cams 702 are located adjacent to or near an edge of the disc 714 and positioned opposite one another. The actuation roller 710 of the switch 706 rolls over a timing cam 702 as the disc 714 rotates about axis 718. Switch 706 may be in a normally open state or a normally closed state. In the normally open scenarios, rotation of the actuation roller 710 causes the switch 706 to transition from its open state to its closed state. In the normally closed scenario, rotation of the actuation roller 710 causes the switch 706 to transition from its closed state to its open state. The duration of switch actuation is defined by the length of a timing cam. The duration of switch actuation is shorter when the timing cam has a relatively short length, and longer when the timing cam has a relatively long length.

In the normally open scenario, a signal is generated on line 708 when switch actuation occurs as a result of the actuation roller 710 rolling over a timing cam 702. In the normally closed scenario, a signal is interrupted on line 708 when switch actuation occurs as a result of the actuation roller 710 rolling over a timing cam 702. When the controller 400 either (i) receives a signal on line 708 or (ii) stops receiving a signal on line 708, controller 400 generates a control signal on control line 508 for actuating valves 506 of the heat source 318.

The present solution is not limited to the roller switch configuration of FIGS. 6-7. Other timing mechanisms can be used herein such as encoders and/or optical switches. In other scenarios, the timing cams 702 may be eliminated and/or replaced with other components (e.g., reflectors, mirrors, notches, grooves, etc.).

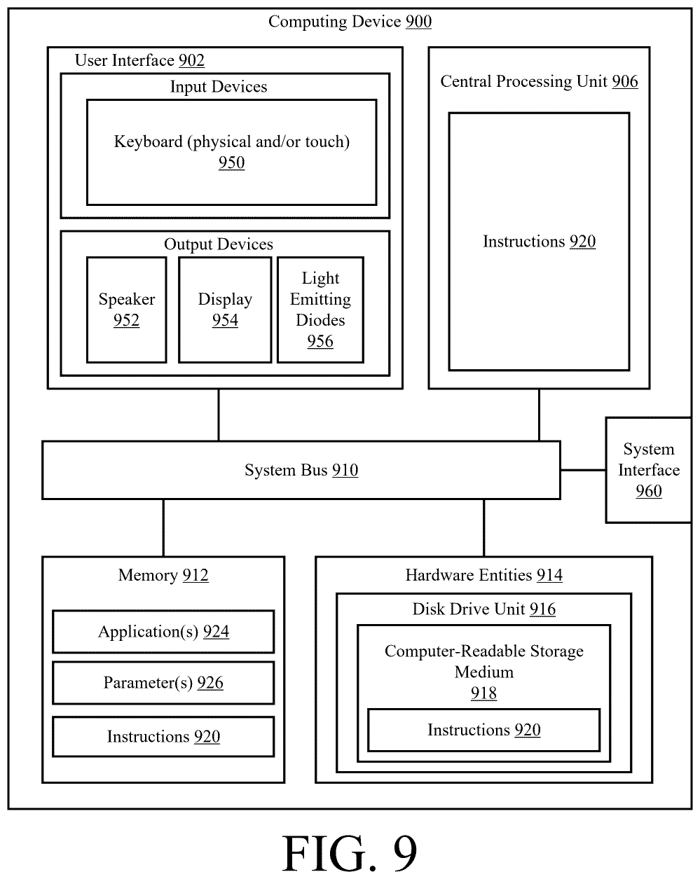

Referring now to FIG. 9, there is provided an illustration of an illustrative architecture for a computing device 900. The controller 400 of FIG. 4 is/are the same as or similar to computing device 900. As such, the discussion of computing device 900 is sufficient for understanding the controllers 400 of FIG. 4.

Computing device 900 may include more or less components than those shown in FIG. 9. However, the components shown are sufficient to disclose an illustrative solution implementing the present solution. The hardware architecture of FIG. 9 represents one implementation of a representative computing device configured to operate a vehicle, as described herein. As such, the computing device 900 of FIG. 9 implements at least a portion of the method(s) described herein.

Some or all components of the computing device 900 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 9, the computing device 900 comprises a user interface 902, a Central Processing Unit (CPU) 906, a system bus 910, a memory 912 connected to and accessible by other portions of computing device 900 through system bus 910, a system interface 960, and hardware entities 914 connected to system bus 910. The user interface can include input devices and output devices, which facilitate user-software interactions for controlling operations of the computing device 900. The input devices include, but are not limited to, a physical and/or touch keyboard 950. The input devices can be connected to the computing device 900 via a wired or wireless connection (e.g., a Bluetooth® connection). The output devices include, but are not limited to, a speaker 952, a display 954, and/or light emitting diodes 956. System interface 960 is configured to facilitate wired or wireless communications to and from external devices (e.g., network nodes such as access points, etc.).

At least some of the hardware entities 914 perform actions involving access to and use of memory 912, which can be a Random Access Memory (RAM), a disk drive, flash memory, a Compact Disc Read Only Memory (CD-ROM) and/or another hardware device that is capable of storing instructions and data. Hardware entities 914 can include a disk drive unit 916 comprising a computer-readable storage medium 918 on which is stored one or more sets of instructions 920 (e.g., software code) configured to implement one or more of the methodologies, procedures, or functions described herein. The instructions 920 can also reside, completely or at least partially, within the memory 912 and/or within the CPU 906 during execution thereof by the computing device 900. The memory 912 and the CPU 906 also can constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding or carrying a set of instructions 920 for execution by the computing device 900 and that cause the computing device 900 to perform any one or more of the methodologies of the present disclosure.

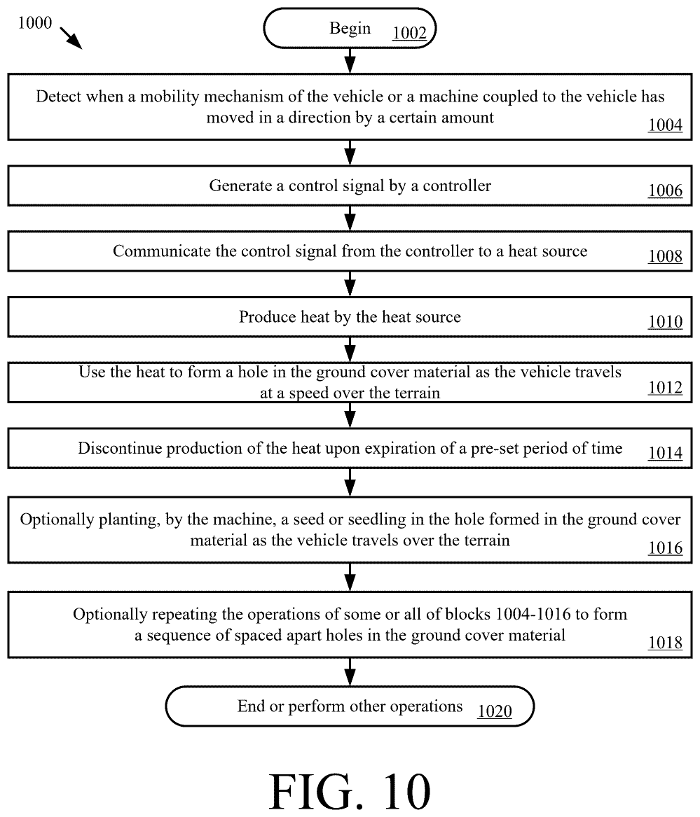

FIG. 10 provides a flow diagram of an illustrative method 1000 for forming holes in a ground cover material (e.g., woven weed barrier 308 of FIG. 3) as a vehicle (e.g., tractor 302) travels over terrain (e.g., terrain 552 of FIG. 5). The operations of method 1000 can be performed in the same or different order than shown. Also, the present solution concerns methods within more or less operations than that shown in accordance with a given application.

Method 1000 begins at 1002 and continues to 1004 where operations are performed to detect when a mobility mechanism of the vehicle (e.g., tractor 302 of FIG. 2) or a machine (e.g., mechanical transplanter 304 of FIG. 3) coupled to the vehicle has moved in a direction (e.g., direction 352 of FIG. 3) by a certain amount. The mobility mechanism can include, but is not limited to, a wheel (e.g., wheel 352 or 310 of FIG. 3), a track, a pulley, an axle, a shaft, a bearing, a drive train component, and/or any other mechanical or electro-mechanical device configured to cause movement or motion of a vehicle. The movement or motion can include, but is not limited to, rotation, climbing, sliding and/or walking. The detection can be made using a detector. The detector can include, but is not limited to, a switch, a proximity sensor, and/or other sensor(s) configured to detect movement of objects. Any known or to be known sensor configured to detect movement can be used here. This detection can be achieved, for example, by allowing a switch (e.g., switch 706 of FIGS. 7-8) to be actuated at a time when a wheel (e.g., wheel 352 or 310 of FIG. 3) of the vehicle (e.g., tractor 302 of FIG. 2) or a machine (e.g., mechanical transplanter 304 of FIG. 3) coupled to the vehicle has rotated in a direction (e.g., direction 352 of FIG. 3) by a certain amount. The certain amount can be selected in accordance with a given application. For example, the certain amount can include, but is not limited to, ninety degrees, one hundred and eight degrees, two hundred seventy degrees, or three hundred sixty degrees.

Actuation the switch may be achieved by, for example: causing a disc (e.g., disc 714 of FIGS. 7-8) to rotate along with a wheel axle (e.g., axle 716 of FIG. 7) of the vehicle or a machine coupled to the vehicle; and allowing an actuation roller (e.g., actuation roller 710 of FIG. 7) of the switch to roll over a timing cam (e.g., timing cam 702 of FIG. 7) coupled to the disc. The timing cam may have ramped end surfaces (e.g., ramped end surfaces 712 of FIG. 7). A duration of the switch actuation may be defined by a length of the timing cam. The switch may be actuated when the actuation roller starts to roll onto the timing cam and the switch is no longer actuated when the actual roller rolls off of the timing cam.

Next in block 1006, a controller (e.g., controller 400 of FIG. 4) performs operations to generate a control signal in response to actuation of the switch. The control signal is communicated from the controller to heat source (e.g., heat source 318 of FIG. 3), as shown by block 1008. The heat source produces heat in block 1010 responsive to the control signal.

The heat production may be achieved, for example, by actuating one or more valves (e.g., valve(s) 506 of FIG. 5) to allow fuel to flow from a fuel tank (e.g., fuel tank 320 of FIG. 3) to one or more torch heads (e.g., torch head(s) 5021, 5022, and/or 5023 of FIG. 5). In the scenario where multiple torch heads are provided, the torch heads may include: a center torch head (e.g., torch head 5021 of FIG. 5) pointing in a first direction (e.g., direction 570 of FIG. 5) perpendicular to the terrain (e.g., terrain 552 of FIG. 5); a first side torch head (e.g., torch head 5022 of FIG. 5) located on a first side of the center torch head so as to point in a second direction (e.g., direction 572 of FIG. 5) towards the center torch head; and/or a second side torch head (e.g., torch head 5023 of FIG. 5) located on an opposing second side of the center torch head so as to point in a third direction (e.g., direction 574 of FIG. 5) towards the center torch head. The second direction is angled relative to the first diction. The third direction is angled relative to the first direction.

The heat is used in 1012 to form a hole in the ground cover material as the vehicle travels at a speed over the terrain. Production of the heat is discontinued in block 1014 upon expiration of a pre-set period of time.

Upon completing 1014, method 1400 may optionally continue with block 1016 and/or 1018. These blocks 1016-1018 involve: optionally planting, by the machine, a seed or seedling in the hole formed in the ground cover material as the vehicle travels over the terrain; and/or optionally repeating the operations of some or all of blocks 1004-1016 to form a sequence of spaced apart holes in the ground cover material. Subsequently, method 1000 continues to 1020 where it ends or other operations are performed (e.g., return to 1002).

In view of the forgoing discussion, the present document concerns implementing systems and methods for forming holes in a ground cover material as a vehicle travels over terrain. The methods comprise: (i) detecting when a mobility mechanism of the vehicle or a machine coupled to the vehicle has moved in a direction by a certain amount; (ii) generating a control signal by a controller responsive to said detecting; (iii) communicating the control signal from the controller to a heat source; (iv) producing heat by the heat source in response to the control signal; and (v) using the heat to form a hole in the ground cover material as the vehicle travels at a speed over the terrain. The listed operations (i)-(v) may be repeated to form a sequence of spaced apart holes in the ground cover material. The method may also comprise discontinuing production of the heat upon expiration of a pre-set period of time.

The mobility mechanism can include, but is not limited to, a wheel. Thus, the detecting can comprise detecting an amount of rotation of the wheel.

The detecting may comprise actuating a switch at a time when a wheel of the vehicle or a machine coupled to the vehicle has rotated in a direction by a certain amount. The actuation of the switch may comprise: causing a disc to rotate along with a wheel axle of the vehicle or a machine coupled to the vehicle; and allowing an actuation roller of the switch to roll over a timing cam coupled to the disc. The timing cam can comprise ramped end surfaces. A duration of the switch actuation may be defined by a length of the timing cam. The switch may be actuated when the actuation roller starts to roll onto the timing cam. The switch may no longer be actuated when the actuation roller rolls off of the timing cam.

The producing heat may comprise actuating one or more valves to allow fuel to flow from a fuel tank to one or more torch heads. The torch head(s) may include, but are not limited to: a center torch head pointing in a first direction perpendicular to the terrain; a first side torch head located on a first side of the center torch head so as to point in a second direction towards the center torch head (the second direction being angled relative to the first direction); and/or a second side torch head located on an opposing second side of the center torch head so as to point in a third direction towards the center torch head (the third direction being angled relative to the first direction).

Additionally or alternatively, the vehicle may comprise a tractor and the machine comprises a mechanical transplanter. The method may also comprise planting, by the mechanical transplanter, a seed or seedling in the hole formed in the ground cover material as the tractor travels over the terrain.

The present disclosure also concerns a system comprising a vehicle and a heating mechanism coupled to the vehicle. The heating mechanism comprises: a detector configured to detect when a mobility mechanism of the vehicle or a machine coupled to the vehicle has moved in a direction by a certain amount; a controller configured to generate a control signal responsive to an actuation of the switch; and a heat source configured to receive the control signal from the controller and produce heat in response to a reception of the control signal. The heat is used to form a hole in a ground cover material as the vehicle travels at a speed over the terrain.

The detector can include, but is not limited to, a switch configured to be actuated at a time when a wheel of the vehicle or a machine coupled to the vehicle has rotated in a direction by a certain amount. The heating mechanism may be configured to: form a sequence of spaced apart holes in the ground cover material; and/or discontinue production of the heat upon expiration of a pre-set period of time.

The actuation of the switch may be achieved by: causing a disc to rotate along with a wheel axle of the vehicle or a machine coupled to the vehicle; and allowing an actuation roller of the switch to roll over a timing cam coupled to the disc. The timing cam may comprise ramped end surfaces. A duration of the switch actuation may be defined by a length of the timing cam. The switch may be actuated when the actuation roller starts to roll onto the timing cam. The switch may no longer be actuated when the actual roller rolls off of the timing cam.

The production of the heat may comprise actuating one or more valves to allow fuel to flow from a fuel tank to one or more torch heads. The torch head(s) may include, but are not limited to: a center torch head pointing in a first direction perpendicular to the terrain; a first side torch head located on a first side of the center torch head so as to point in a second direction towards the center torch head (the second direction being angled relative to the first direction); and/or a second side torch head located on an opposing second side of the center torch head so as to point in a third direction towards the center torch head (the third direction being angled relative to the first direction).

The vehicle can include, but is not limited to, a tractor. The machine can include, but is not limited to, a mechanical transplanter configured to plant a seed or seedling in the hole formed in the ground cover material as the tractor travels over the terrain.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with a particular implementation is included in at least one embodiment. Thus, discussions of the features and advantages, and similar language, throughout the specification may, but do not necessarily, refer to the same embodiment.

Furthermore, the described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A method for forming holes in a ground cover material as a vehicle travels over terrain, comprising:
detecting when a mobility mechanism of the vehicle or a machine coupled to the vehicle has moved in a direction by a certain amount;
generating a control signal by a controller responsive to said detecting;
communicating the control signal from the controller to a heat source;
producing heat by the heat source in response to the control signal; and
using the heat to form a hole in the ground cover material as the vehicle travels at a speed over the terrain.

2. The method according to claim 1, wherein the detecting comprises actuating a switch at a time when a wheel of the vehicle or a machine coupled to the vehicle has rotated in a direction by a certain amount.

3. The method according to claim 1, wherein the mobility mechanism comprises a wheel and said detecting comprises detecting an amount of rotation of the wheel.

4. The method according to claim 1, repeating said detecting, generating, communicating, producing and using to form a sequence of spaced apart holes in the ground cover material.

5. The method according to claim 1, further comprising discontinuing production of the heat upon expiration of a pre-set period of time.

6. The method according to claim 2, wherein said actuation the switch comprises:
causing a disc to rotate along with a wheel axle of the vehicle or a machine coupled to the vehicle; and
allowing an actuation roller of the switch to roll over a timing cam coupled to the disc.

7. The method according to claim 6, wherein the timing cam comprises ramped end surfaces.

8. The method according to claim 6, wherein a duration of said actuating is defined by a length of the timing cam.

9. The method according to claim 8, wherein the switch is actuated when the actuation roller starts to roll onto the timing cam and the switch is no longer actuated when the actuation roller rolls off of the timing cam.

10. The method according to claim 1, wherein said producing heat comprises actuating one or more valves to allow fuel to flow from a fuel tank to one or more torch heads.

11. The method according to claim 10, wherein the one or more torch heads comprises:
a center torch head pointing in a first direction perpendicular to the terrain;
a first side torch head located on a first side of the center torch head so as to point in a second direction towards the center torch head, the second direction being angled relative to the first direction; and
a second side torch head located on an opposing second side of the center torch head so as to point in a third direction towards the center torch head, the third direction being angled relative to the first direction.

12. The method according to claim 1, wherein:
the vehicle comprises a tractor and the machine comprises a mechanical transplanter; and
the method further comprises planting, by the mechanical transplanter, a seed or seedling in the hole formed in the ground cover material as the tractor travels over the terrain.

13. A system, comprising:
a vehicle; and
a heating mechanism coupled to the vehicle and comprising:
a detector configured to detect when a mobility mechanism of the vehicle or a machine coupled to the vehicle has moved in a direction by a certain amount;
a controller configured to generate a control signal responsive to an actuation of the switch;
a heat source configured to receive the control signal from the controller and produce heat in response to a reception of the control signal; and
wherein the heat is used to form a hole in a ground cover material as the vehicle travels at a speed over the terrain.

14. The system according to claim 13, wherein the detector comprises a switch configured to be actuated at a time when a wheel of the vehicle or a machine coupled to the vehicle has rotated in a direction by a certain amount.

15. The system according to claim 13, wherein the heating mechanism is configured to form a sequence of spaced apart holes in the ground cover material.

16. The system according to claim 13, wherein the heating mechanism is configured to discontinue production of the heat upon expiration of a pre-set period of time.

17. The system according to claim 13, wherein actuation of the switch is achieved by:
causing a disc to rotate along with a wheel axle of the vehicle or a machine coupled to the vehicle; and
allowing an actuation roller of the switch to roll over a timing cam coupled to the disc.

18. The system according to claim 17, wherein the timing cam comprises ramped end surfaces.

19. The system according to claim 17, wherein a duration of said actuation of the switch is defined by a length of the timing cam.

20. The system according to claim 19, wherein the switch is actuated when the actuation roller starts to roll onto the timing cam and the switch is no longer actuated when the actual roller rolls off of the timing cam.

21. The system according to claim 13, wherein production of the heat comprises actuating one or more valves to allow fuel to flow from a fuel tank to one or more torch heads.

22. The system according to claim 21, wherein the one or more torch heads comprises:
a center torch head pointing in a first direction perpendicular to the terrain;
a first side torch head located on a first side of the center torch head so as to point in a second direction towards the center torch head, the second direction being angled relative to the first direction; and
a second side torch head located on an opposing second side of the center torch head so as to point in a third direction towards the center torch head, the third direction being angled relative to the first direction.

23. The system according to claim 13, wherein the vehicle comprises a tractor and the machine comprises a mechanical transplanter configured to plant a seed or seedling in the hole formed in the ground cover material as the tractor travels over the terrain.
